(19) United States
(12) Patent Application Publication
(10) Pub. No.: US 2020/0023437 A1
(43) Pub. Date: Jan. 23, 2020

(54) METHOD FOR PRODUCING THREE-DIMENSIONAL MOLDED OBJECT

(71) Applicant: Sodick Co., Ltd., Kanagawa (JP)

(72) Inventor: Itaru MATSUMOTO, Kanagawa (JP)

(73) Assignee: Sodick Co., Ltd., Kanagawa (JP)

(21) Appl. No.: 16/446,898

(22) Filed: Jun. 20, 2019

(30) Foreign Application Priority Data
Jul. 18, 2018 (JP) 2018-135353

(51) Int. Cl. B22F 3/24; B22F 3/105; B33Y 10/00; B33Y 40/00

(52) U.S. Cl. CPC B22F 3/24; B22F 3/1055; B33Y 10/00; B22F 2301/35; B22F 2003/248; B22F 2003/247; B33Y 40/00

(57) ABSTRACT

In the solidified layer forming step, at least one solidified layer is formed. In the temperature lowering step, the solidified layer is cooled from the first temperature equal to or higher than a martensitic transformation finish temperature to the second temperature lower than the first temperature and equal to or lower than a martensitic transformation start temperature. In the temperature maintaining step, a temperature of the solidified layer lowered to the second temperature is maintained at a predetermined cutting temperature. In the roughing step, a surface of the solidified layer is processed so as to leave a predetermined processing margin.

### CROSS-REFERENCE TO RELATED APPLICATION

This application claims priority to Japanese Patent Application, No. 2018-135353 filed on Jul. 18, 2018, the entire contents of which are incorporated by reference herein.

### TECHNICAL FIELD

The present invention relates to a method for producing a three-dimensional molded object.

### BACKGROUND ART

There are several methods for metal lamination molding, and powder bet fusion can be exemplified. In powder bet fusion, firstly, a material layer consisting of material powder spread to a predetermined thickness is formed. A solidified layer is then formed by irradiating a predetermined portion of the material layer with a laser beam or an electron beam to sinter or melt the material powder at an irradiated position. The material layer and the solidified layer are repeatedly formed, and thus a solidified object having a desired three-dimensional shape in which a plurality of solidified layers is laminated is molded. A first material layer may be formed on a base plate disposed in a chamber. Hereinafter, the term “solidifying” includes sintering and melting.

In such metal lamination molding, the solidified layer formed by the irradiation of the laser beam or the electron beam is at a very high temperature immediately after the solidification. The temperature of the solidified layer then drops rapidly due to heat radiation into the solidified layers already formed, the base plate or an inert gas atmosphere. At this time, the solidified layer made of metal contracts in volume because a coefficient of thermal expansion of the metal is positive. On the other hand, since the amount of contraction is limited by the adjacent solidified layer or the base plate, a tensile stress remains.

If the material is martensitic metal, the solidified layer immediately after formation contains an austenite phase, and the austenite phase is transformed into a martensitic phase by cooling under predetermined conditions, such as a temperature condition. Since martensitic transformation causes volume expansion, a compressive stress is generated.

Under the technical background described above, the present applicant has proposed, in U.S. Patent Application Publication No. 2019/0061001, a method for producing a three-dimensional molded object in which the tensile stress due to the contraction of the solidified layer is reduced by the compressive stress due to the martensitic transformation to control the residual stress of the molded object. In the method, the solidified layers are cooled every time a predetermined number of the solidified layers are formed so as to intentionally advance the martensitic transformation. Thereby, the deformation of the three-dimensional molded object can be suppressed.

In addition, as described in U.S. Patent Application Publication No. 2019/0061001, cutting may be performed on an end surface of the solidified layer every time a predetermined number of the solidified layers are formed. A highly accurate three-dimensional molded object can be thus obtained.

### SUMMARY OF INVENTION

### Technical Problem

When molding is performed as described above while intentionally advancing the martensitic transformation by performing temperature control on the solidified layers every time the predetermined number of the solidified layers are molded, the formation of the solidified layer is interrupted during the temperature control. Further, while cutting is performed on the solidified layer each time the predetermined number of the solidified layers are molded, the material layer or the solidified layer cannot be formed. Therefore, in a manufacturing method in which the temperature control or cutting of the solidification layers are performed during molding, molding time tends to be longer although the highly accurate three-dimensional molded object can be obtained.

The present invention has been made in consideration of such circumstances. An object of the present invention is to shorten the molding time in the method for producing a three-dimensional molded object in which the temperature control is performed every time the predetermined number of the solidified layers are formed, and cutting is performed during molding.

### Solution to Problem

According to the present invention, provided is a method for producing a three-dimensional molded object, comprising: a solidified layer forming step of performing, one or more times, a recoating step of forming a material layer on a predetermined molding region and a solidifying step of irradiating the material layer with a laser beam or an electron beam to form a solidified layer; a temperature lowering step of cooling the solidified layer from a first temperature to a second temperature, the first temperature being equal to or higher than a martensitic transformation finish temperature of the solidified layer, and the second temperature being lower than the first temperature and equal to or lower than a martensitic transformation start temperature of the solidified layer; a temperature maintaining step of maintaining a temperature of the solidified layer which is lowered to the second temperature in the temperature lowering step, at a predetermined cutting temperature; a roughing step of cutting a surface of the solidified layer so as to leave a predetermined processing margin; and a finishing step of cutting a surface of the solidified layer so as to leave a processing margin smaller than the predetermined processing margin left in the roughing step, wherein the roughing step is started during the temperature lowering step; and the finishing step is performed during the temperature maintaining step.

### Advantageous Effects of Invention

According to the present invention, the roughing step is started before cooling of the solidified layers is completed. Since the temperature lowering step and the roughing step are performed in parallel, the molding time can be shortened as in the case where time required for the roughing step is shortened.

### BRIEF DESCRIPTION OF DRAWINGS

FIG. 1 is a schematic configuration view of a lamination molding apparatus according to an embodiment of the present invention.

FIG. 2 is a perspective view of a recoater head 11 according to the embodiment of the present invention.

FIG. 3 is a perspective view of the recoater head 11 according to the embodiment of the present invention from another angle.

FIG. 4 is a schematic configuration view of an irradiation device 13 according to the embodiment of the present invention.

FIG. 5 is a schematic configuration view of one example of a molding table 5 comprising a temperature adjusting device 90 according to the embodiment of the present invention.

FIG. 6 is an explanatory drawing of a lamination molding method using a lamination molding apparatus according to the embodiment of the present invention.

FIG. 7 is an explanatory drawing of the lamination molding method using the lamination molding apparatus according to the embodiment of the present invention.

FIG. 8 is an explanatory drawing of the lamination molding method using the lamination molding apparatus according to the embodiment of the present invention.

FIG. 9 is an explanatory drawing of the lamination molding method using the lamination molding apparatus according to the embodiment of the present invention.

FIG. 10 is a graph showing temperature change of a predetermined portion of an upper surface layer in the embodiment of the present invention.

FIG. 11 is a graph showing temperature change of a predetermined portion of an upper surface layer in another embodiment.

### DESCRIPTION OF EMBODIMENTS

Hereinafter, embodiments of the present invention will be described with reference to the drawings. Here, the characteristic matters shown in the embodiments can be combined with each other. In addition, each of the characteristic matters can individually constitute an invention. Here, in each of the drawings, a part of the constitutions may be omitted for better visibility.

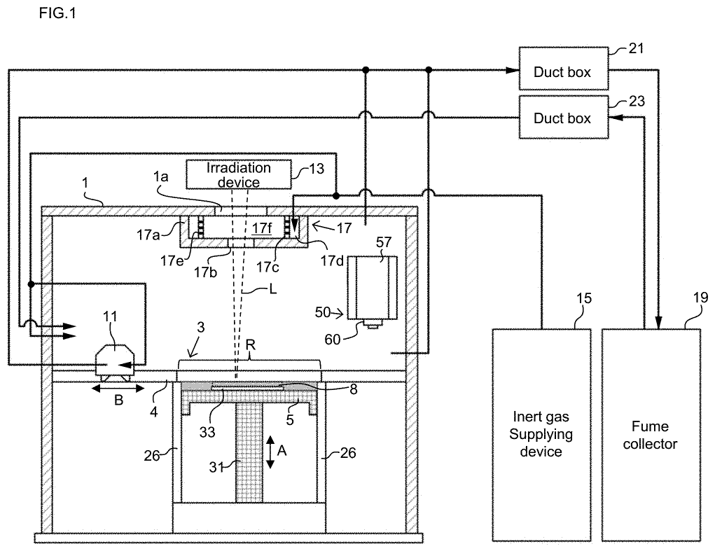

As shown in FIG. 1, a lamination molding apparatus of the present embodiment forms a material layer 8 consisting of material powder which can be transformed to generate a martensitic phase, such as carbon steel or martensitic stainless steel, and irradiates a predetermined portion of the material layer 8 with a laser beam L to solidify the material powder at an irradiated position and to form a solidified layer. The lamination molding apparatus laminates a plurality of solidified layers by repeating the formation of the material layer 8 and the solidified layer to mold a solidified body 81 having a desired three-dimensional shape. The lamination molding apparatus of the present embodiment comprises a chamber 1, a material layer forming device 3, an irradiation device 13, a cutting device 50, and a temperature adjusting device 90.

The chamber 1 covers a predetermined molding region R, which is an area where the solidified body 81 is formed. An inert gas having a predetermined concentration is supplied to the chamber 1, while the inert gas containing fume generated when the material layer 8 is solidified is exhausted from the chamber 1. Further, the inert gas exhausted from the chamber 1 is returned to the chamber 1 after the fume is removed from the inert gas. Specifically, an inert gas supplying device 15 is connected to the chamber 1, and a fume collector 19 is connected to the chamber 1 via duct boxes 21, 23. The inert gas supplying device 15 is, for example, an inert gas generator of a membrane separation system or a PSA system, or a gas cylinder in which the inert gas is stored. The inert gas supplying device 15 supplies the inert gas from a supply port provided in the chamber 1 and fills the chamber 1 with the inert gas having the predetermined concentration. Further, the inert gas containing a large amount of the fume exhausted from an exhaust port of the chamber 1 is sent to the fume collector 19. The fume is removed from the inert gas, and the inert gas is then returned to the chamber 1. In the present invention, the inert gas is a gas that does not substantially react with the material layer 8, and is appropriately selected from nitrogen gas, argon gas, helium gas, and the like, according to a type of the material layer 8.

In the chamber 1, the material layer forming device 3 is provided. The material layer forming device 3 comprises a base 4 and a recoater head 11. The base 4 has the molding region R where a three-dimensional molded object is formed. In the molding region R, a molding table 5 is provided. The molding table 5 can be driven by a molding table driving mechanism 31 and move in a vertical direction which is shown as an arrow A in FIG. 1. At the time of using the lamination molding apparatus, a base plate 33 may be disposed on the molding table 5 to form the material layer 8 on the molding table 5. A predetermined irradiated region exists within the molding region R and roughly matches a region surrounded by a contour shape of the desired solidified body 81. Powder retaining walls 26 are provided around the molding table 5. Unsolidified material powder is retained in a powder retaining space surrounded by the powder retaining walls 26 and the molding table 5.

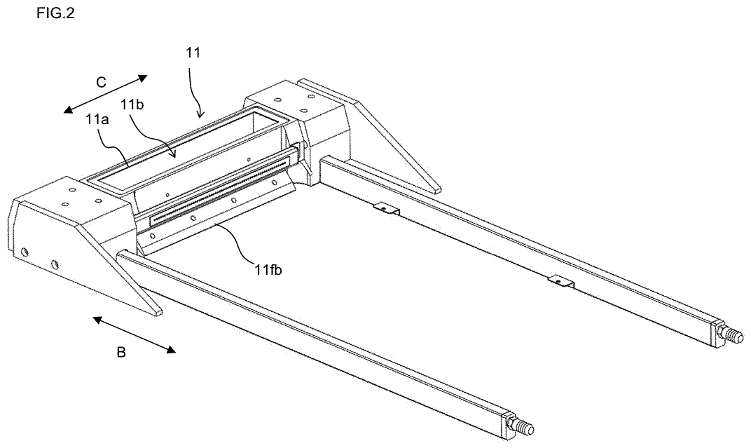

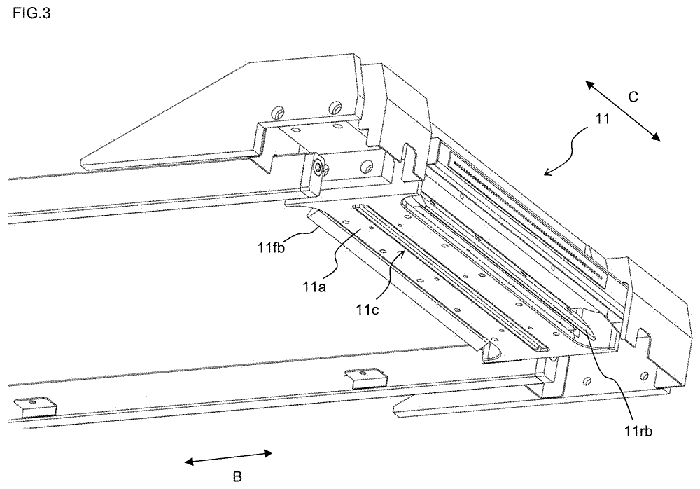

As shown in FIG. 2 and FIG. 3, the recoater head 11 has a material holding section 11a, a material supplying section 11b, and a material discharging section 11c. The material powder is accommodated in the material holding section 11a. The material supplying section 11b is provided on an upper surface of the material holding section 11a and serves as an opening receiving the material powder supplied from a material supplying device (not shown) to the material holding section 11a. The material discharging section 11c is provided on a bottom surface of the material holding section 11a and discharges the material powder accommodated in the material holding section 11a. The recoater head 11 moves along a horizontal direction shown as an arrow B. The material discharging section 11c has a slit shape extending in a horizontal direction shown as an arrow C, which is orthogonal to the arrow B.

Further, a blade 11fb is provided on one side of the recoater head 11, while a blade 11rb is provided on the other side of the recoater head 11. The blades 11fb and 11rb spread the material powder. That is, the blades 11fb and 11rb planarize the material powder discharged from the material discharging section 11c to form the material layer 8.

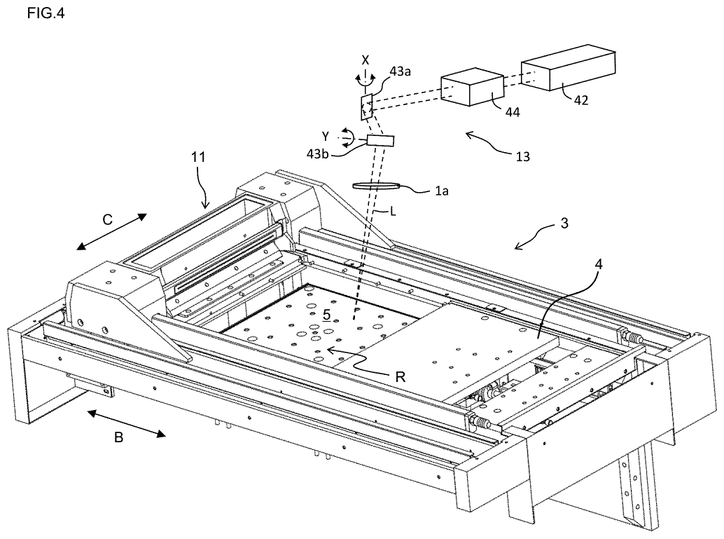

The irradiation device 13 is provided above the chamber 1. The irradiation device 13 may be any device that can irradiate the material layer 8 with the laser beam L or an electron beam to solidify the material layer 8. The irradiation device 13 of the present embodiment irradiates a predetermined portion of the material layer 8 formed on the molding region R with the laser beam L to solidify the material powder at the irradiated position. Specifically, as shown in FIG. 4, the irradiation device 13 comprises a light source 42, a two-axis galvanometer scanner, and a focus control unit 44. The galvanometer scanner comprises a pair of galvanometer mirrors 43a, 43b and actuators for rotating each of the galvanometer mirrors 43a, 43b.

The light source 42 emits the laser beam L. The beam L may be any beam that can solidify the material powder. The beam L is, for example, a CO₂ laser, a fiber laser, or a YAG laser.

The focus control unit 44 focuses the laser beam L output from the light source 42 to adjust it to a desired spot diameter.

The galvanometer mirrors 43a, 43b scan two-dimensionally the laser beam L output from the light source 42. Rotational angles of the galvanometer mirrors 43a, 43b are respectively controlled in accordance with magnitudes of rotational angle control signals input from a control device (not shown). It is thus possible to irradiate a desired position with the laser beam L by changing the magnitude of the rotation angle control signal input to each actuator of the galvanometer scanner.

The laser beam L passed through the galvanometer mirrors 43a, 43b is transmitted through a protective window 1a provided in the chamber 1, and the material layer 8 formed in the molding region R is irradiated with the laser beam L. The protective window 1a is formed of a material that can transmit the laser beam L. For example, when the laser beam L is a fiber laser or a YAG laser, the protective window 1a can be made of quartz glass.

A protective window contamination preventing device 17 is provided on an upper surface of the chamber 1 so as to cover the protective window 1a. The protective window contamination preventing device 17 comprises a cylindrical housing 17a and a cylindrical diffusion member 17c disposed in the housing 17a. An inert gas supplying space 17d is provided between the housing 17a and the diffusion member 17c. Further, an opening 17b is provided inside the diffusion member 17c on a bottom surface of the housing 17a. The diffusion member 17c is provided with a large number of pores 17e, and the clean inert gas supplied to the inert gas supplying space 17d is filled into a clean room 17f through the pores 17e. The clean inert gas filled in the clean room 17f is then ejected downward of the protective window contamination preventing device 17 through the opening 17b.

The cutting device 50 comprises a processing head 57 provided with a spindle 60. The processing head 57 moves the spindle 60 to a desired position by means of a processing head driving mechanism (not shown). The spindle 60 is configured so that a cutting tool, such as an end mill (not shown), can be attached thereto to rotate the tool. The spindle 60 can perform cutting of a surface or an unnecessary portion of the solidified layer obtained by solidifying the material layer 8. Preferably, plural types of cutting tools are used, and the cutting tools can be exchanged during molding by an automatic tool changer (not shown).

The temperature adjusting device 90 performs temperature control of the solidified layers every time one or more solidified layers are formed, so that the temperature of the solidified layers shifts from a first temperature to a second temperature. The first temperature is equal to or higher than a martensitic transformation finish temperature of the solidified layer. The second temperature is lower than the first temperature, and equal to or lower than a martensitic transformation start temperature of the solidified layer. Hereinafter, the solidified layers subjected to the temperature control by the temperature adjusting device 90 are referred to as an upper surface layer. The temperature adjusting device 90 comprises at least one of a heater 92 for heating the upper surface layer and a cooler 93 for cooling the upper surface layer, and preferably comprises both of the heater 92 and the cooler 93.

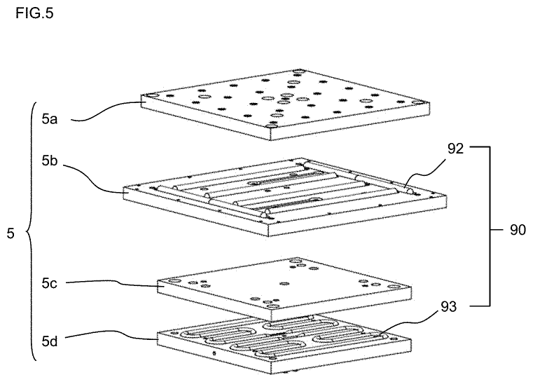

The temperature adjusting device 90 is provided, for example, inside the molding table 5. As shown in FIG. 5, the molding table 5 comprises a top plate 5a and three support plates 5b, 5c, and 5d. The heater 92 of the temperature adjusting device 90 is provided between the top plate 5a and the support plate 5b. The cooler 93 of the temperature adjusting device 90 is provided between the support plate 5c and the support plate 5d. The heater 92 is, for example, an electric heater or a pipeline through which a heating medium flows. The cooler 93 is, for example, a pipeline through which a cooling medium flows. It is possible, with the temperature adjusting device 90 described above, to adjust the temperature of the upper surface layer to a desired temperature via the base plate 33 in contact with the top plate 5a of the molding table 5 set to the desired temperature and the lower solidified layers.

In this regard, the material layer 8 is preferably preheated to a predetermined temperature at the time of solidification. The temperature adjusting device 90 provided at the molding table 5 also acts as a preheating device of the material layer 8. For example, the material layer 8 is maintained at the first temperature by the temperature adjusting device 90.

The temperature adjusting device 90 may have another configuration, and heating or cooling of the upper surface layer may be performed from an upper side of the upper surface layer. For example, a halogen lamp may be provided as the heater 92. For example, a blower may be provided as the cooler 93 to spray a gas, such as a cooled inert gas, to the upper surface layer. By heating or cooling the upper surface layer from the upper side, it is possible to quickly perform the temperature control of the upper surface layer even after forming a large number of solidified layers.

The upper surface layer is cooled from the first temperature to the second temperature by the temperature adjusting device 90 every time a predetermined number of the solidified layers are formed. The upper surface layer before being cooled contains an austenite phase, and at least a portion of the austenite phase transforms into a martensitic phase. It is possible, with the temperature adjusting device 90 described above, to mold the three-dimensional molded object while reducing a tensile stress due to thermal contraction of the solidified layer by a compressive stress due to the martensitic transformation.

The first temperature and the second temperature may be changed during molding as long as all of the temperature conditions (1) to (3) are satisfied:

(1) The first temperature is equal to or higher than the martensitic transformation finish temperature of the solidified layer.

(2) The second temperature is lower than the first temperature.

(3) The second temperature is equal to or lower than the martensitic transformation start temperature of the solidified layer.

For example, by measuring a direction and magnitude of warpage generated in the solidified body 81 or the base plate 33 after cooling the upper surface layer, the first temperature or the second temperature may be reconfigured so that the tensile stress due to the thermal contraction and the compressive stress due to the martensitic transformation are balanced. Specifically, when the tensile stress is large, a difference between the first temperature and the second temperature is increased. When the compressive stress is large, the difference between the first temperature and the second temperature is reduced.

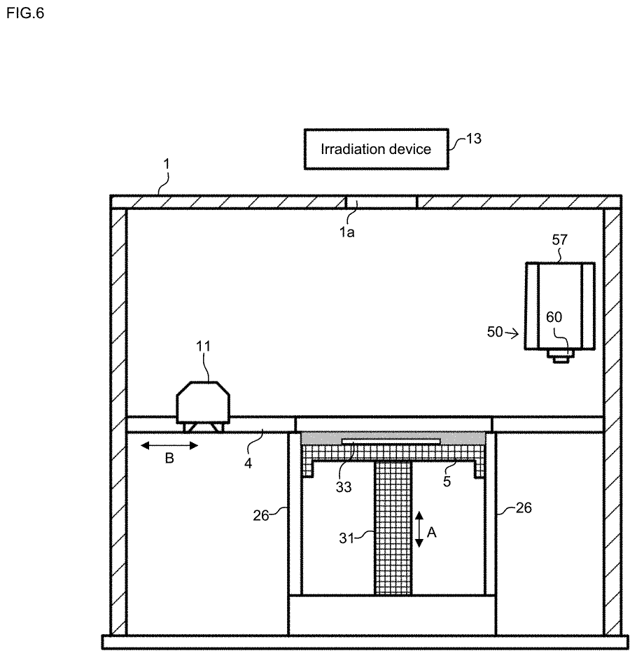

A method for producing the three-dimensional molded object by means of the afore-mentioned lamination molding apparatus is described below with reference to FIG. 6 to FIG. 10. The method for producing the three-dimensional molded object of the present embodiment comprises a solidified layer forming step of laminating the predetermined number of the solidified layers, a cooling step of cooling the predetermined number of the solidified layers, that is, the upper surface layer, and a cutting step of cutting the solidified layer. The solidified layer forming step comprises a recoating step of forming the material layer 8 on the molding region R and a solidifying step of forming the solidified layer by irradiating the material layer 8 with the laser beam L or the electron beam. The recoating step and the solidifying step are repeated until the predetermined number of the solidified layers are formed.

First, a first recoating step is performed. As shown in FIG. 6, the base plate 33 is placed on the molding table 5, and a height of the molding table 5 is adjusted to an appropriate position. In this state, the recoater head 11 with the material powder filled in the material holding section 11a thereof is moved from a left side to a right side of the molding region R to form a first material layer 8 on the base plate 33.

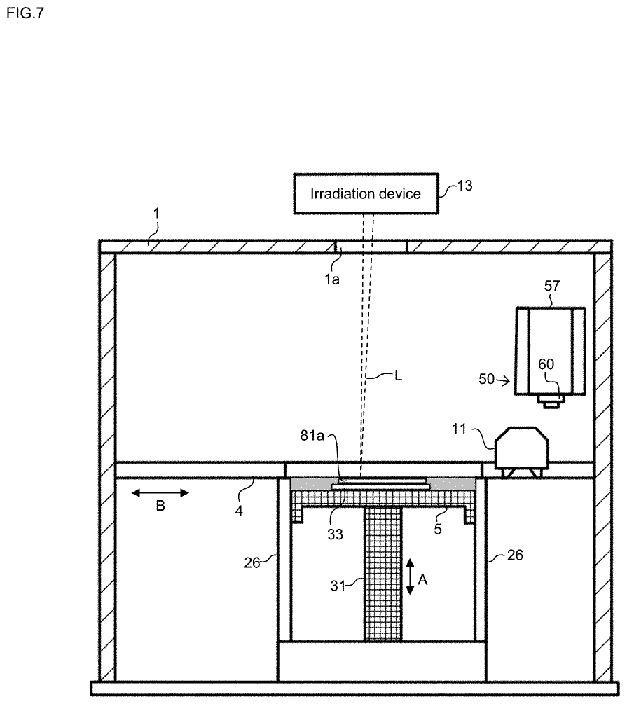

Subsequently, a first solidifying step is performed. The predetermined portion of the first material layer 8 is irradiated with the laser beam L to solidify the material layer 8. A first solidified layer 81a is thus formed, as shown in FIG. 7.

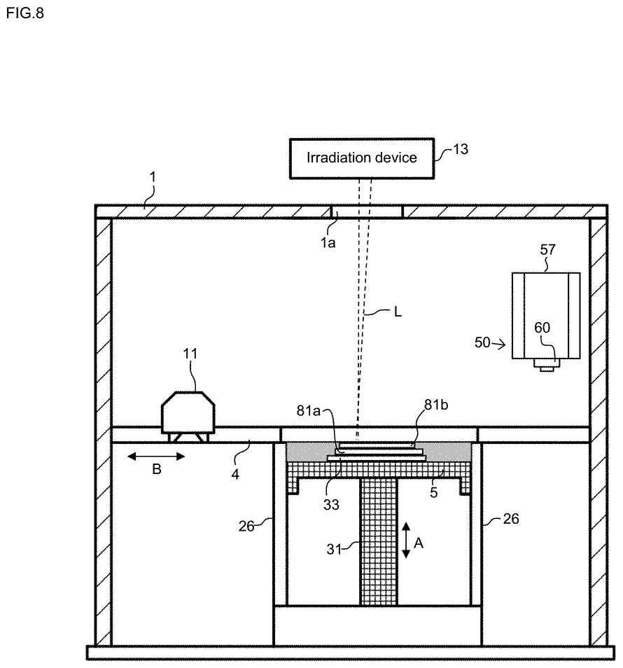

When the cooling step is performed on a plurality of solidified layers, the solidified layer forming step is subsequently performed. Similar to the first recoating step and the first solidifying step, a second recoating step and a second solidifying step are performed. The molding table 5 is lowered by a thickness of the material layer 8. The recoater head 11 is moved from the right side to the left side of the molding region R, and a second material layer 8 is formed on the first solidified layer 81a. The predetermined portion in the second material layer 8 is irradiated with the laser beam L to solidify the material layer 8. Thus, as shown in FIG. 8, a second solidified layer 81b is formed.

The recoating step and the solidifying step are performed a predetermined number of times according to the procedure described above, and the solidified body 81 formed by laminating the solidified layers is formed. In this regard, it is preferable that the molding table 5 is preheated, during the solidified layer forming step, to a temperature suitable for solidifying the material layer 8. In the present embodiment, the molding table 5 is heated at the first temperature by the temperature adjusting device 90 during the solidified layer forming step. That is, the temperature adjusting device 90 preheats the material layer 8 during the solidified layer forming step and performs the temperature control at the first temperature sequentially on the formed solidified layer. The cooling step can be thus performed promptly after the predetermined number of the solidified layers are formed.

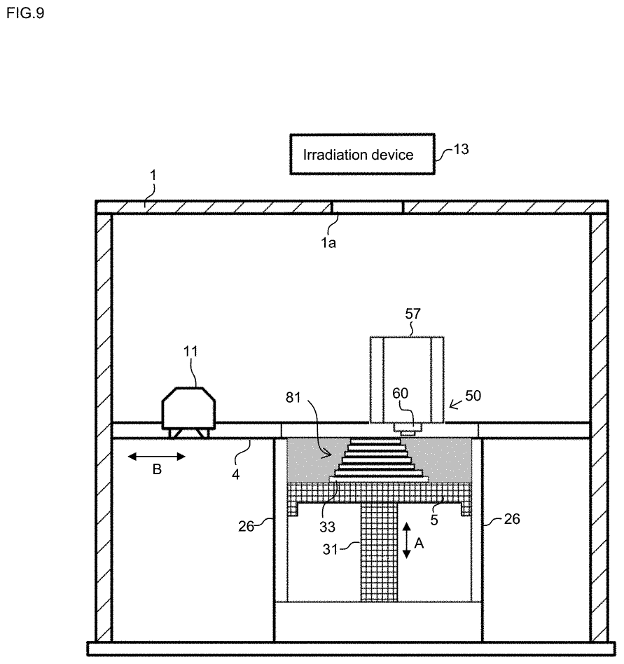

After the predetermined number of the solidified layers is formed, the cooling step and the cutting step are performed in parallel. The cooling step comprises a temperature lowering step of cooling the upper surface layer from the first temperature to the second temperature and a temperature maintaining step of maintaining the temperature of the upper surface layer which is lowered to the second temperature in the temperature lowering step, at a predetermined cutting temperature. The cutting step comprises a roughing step of cutting a surface of the solidified layer so as to leave a predetermined processing margin and a finishing step of cutting the surface of the solidified layer so as to leave a processing margin smaller than the predetermined processing margin left in the roughing step. In the cutting step, as shown in FIG. 9, the spindle 60 of the cutting device 50 is moved to the vicinity of the solidified body 81, and the cutting tool gripped by the spindle 60 performs desired cutting on the surface of the solidified body 81.

In the roughing step, rough cutting is performed on the solidified body 81. On the other hand, in the finishing step, cutting with precise shape processing is performed on the solidified body 81 after the roughing step. During the temperature lowering step, the solidified body 81 is being continuously deformed by the contraction due to cooling and the expansion due to the martensitic transformation, and a displacement of the solidified body 81 is not stable. Therefore, even if cutting is performed during the temperature lowering step, it is difficult to achieve a target shape accuracy. Further, if cutting is performed beyond a desired processing shape, the three-dimensional molded object during molding may be fatally damaged. Therefore, cutting is usually performed after the temperature lowering step is completed and the displacement is stabilized. However, since the roughing step aims at roughly removing the material from the solidified body 81, a processing error may be large and may not be constant. After the roughing step, the processing error can be removed in one or more finishing steps after the roughing step, provided that there is a sufficient processing margin for the finishing step. As described above, since high-precision cutting is not required at the stage of the roughing step, the roughing step can be performed on the solidified body 81 before the displacement is stabilized. Therefore, the roughing step is performed during the temperature lowering step.

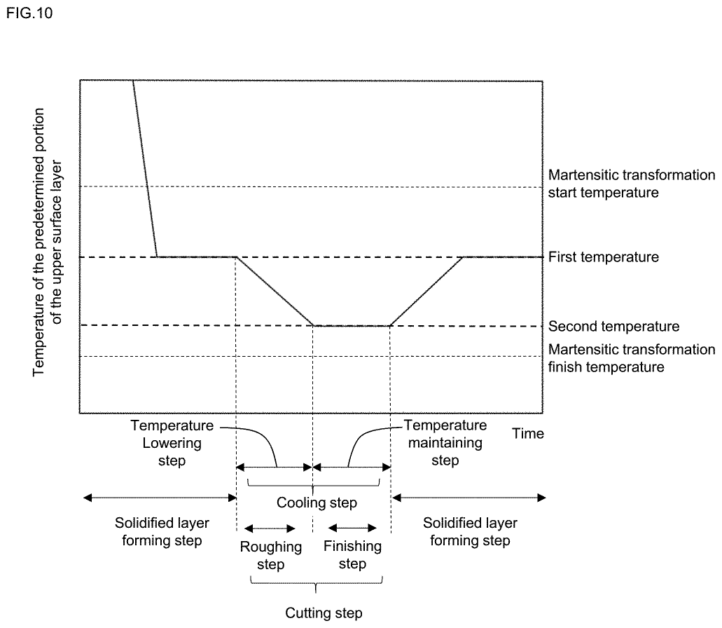

FIG. 10 is a graph showing a temperature of a predetermined portion of the upper surface layer of the solidified body 81. In the solidifying step of the solidified layer forming step, the material layer 8 at the irradiated position is heated to a very high temperature as a result of being irradiated with the laser beam L. The material layer 8 at the portion irradiated with the laser beam L is solidified and becomes a part of the upper surface layer. The temperature adjusting device 90 controls the temperature of the predetermined portion of the upper surface layer after being irradiated with the laser beam L to the first temperature. In the present embodiment, since the temperature of the molding table 5 is controlled at the first temperature by the temperature adjusting device 90, the temperature of the predetermined portion of the upper surface layer is controlled at the first temperature so as to be in thermal equilibrium with the temperature of the molding table 5.

After the predetermined number of the solidified layers are formed, the temperature lowering step is performed. The temperature adjusting device 90 sets the temperature of the molding table 5 to the second temperature. The temperature of the upper surface layer is thus cooled to the second temperature by the molding table 5 via the base plate 33 and the lower solidified layers. That is, cooling of the upper surface layer is performed in a temperature range between the martensitic transformation start temperature of the upper surface layer and the martensitic transformation finish temperature of the upper surface layer. At this time, the martensitic transformation occurs in the upper surface layer, and volume expansion occurs. This reduces the tensile stress due to the thermal contraction of the upper surface layer.

The roughing step is performed in parallel with the temperature lowering step. The roughing step is started simultaneously with the temperature lowering step or until the temperature lowering step is started and then completed. As described above, although the volume of the upper surface layer changes during the temperature lowering step, the roughing step can be performed regardless of the volume change of the solidified body 81 since the roughing step aims at removing a surplus portion from the solidified body 81 so as to leave the sufficient processing margin. In this regard, it is preferable that a duration of the roughing step is shorter than a duration of the temperature lowering step, and that the roughing step is completed before completion of the temperature lowering step. Molding time can be thus shortened by the time corresponded to the duration of the roughing step.

After the completion of the temperature lowering step, that is, after the temperature of the upper surface layer reaches the second temperature, the temperature maintaining step is performed by the temperature adjusting device 90. In the temperature maintaining step, the temperature of the upper surface layer is maintained at the predetermined cutting temperature. The cutting temperature may be at any temperature as long as the solidified body 81 can be cut while suppressing an influence of the expansion or the contraction due to the temperature change. In the temperature maintaining step of the present embodiment, the temperature of the solidified body 81 which has reached the second temperature in the temperature lowering step is maintained at the second temperature. That is, the cutting temperature is equal to the second temperature. In this regard, the cutting temperature may be, for example, normal temperature. The normal temperature is specifically a temperature between about 5° C. and about 35° C.

The finishing step is performed in parallel with the temperature maintaining step. The finishing step aims at cutting with precise shape processing of the solidified body 81, as described above. Therefore, a large volume change of the solidified body 81 due to the temperature change is not allowed during the finishing step. The finishing step is thus performed during the temperature maintaining step, because the temperature of the upper surface layer of the solidified body 81 is maintained at the cutting temperature at which cutting can be performed while suppressing the influence of the displacement. Here, the cutting temperature is the second temperature. As a result, the finishing step is performed on the dimensionally stable solidified body 81, and the precise shape processing is achieved.

After the temperature maintaining step is completed, the temperature adjusting device 90 sets the temperature of the molding table 5 at the first temperature again, and the solidified layer forming step is performed. In this way, the solidified layer forming step, the cooling step, and the cutting step are repeated.

As described above, in the present embodiment, the roughing step of the cutting step is performed during the temperature lowering step. The temperature lowering step and a part of the cutting step are simultaneously performed, and the overall molding time is reduced as compared to the case where each step is sequentially performed.

Further, after the temperature lowering step, the finishing step is performed in the temperature maintaining step. Since the finishing step is performed while the temperature of the solidified body 81 is maintained at the cutting temperature, which is the second temperature in the present embodiment, precise cutting can be performed without being subjected to the influence of the deformation caused by the temperature change of the solidified body 81.

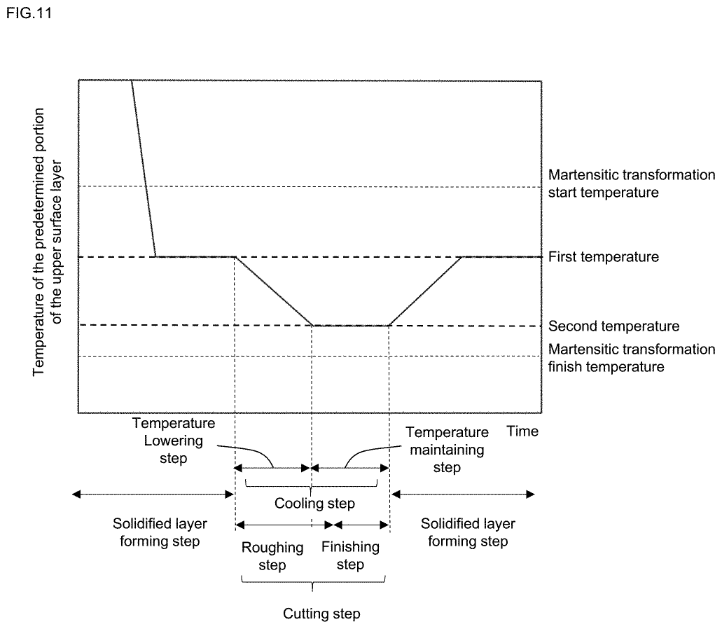

The scope of application of the technical idea of the present disclosure is not limited to the embodiments described above. For example, as shown in FIG. 11, the roughing step may be started simultaneously with the temperature lowering step and may be performed so as to be completed after completion of the temperature lowering step and in the middle of the temperature maintaining step. In this case, the molding time is reduced by a working time of the temperature lowering step.

Further, the duration of the roughing step may be measured, and a start timing of the finishing step may be determined based on the measured duration. The finishing step is thus performed more reliably after the completion of the temperature lowering step.

Further, the cutting step may be selectively performed. That is, while repeating the solidified layer forming step and the cooling step, the cutting step may be performed every time the cooling step is performed, or the cutting step may be performed only when the specific cooling step is performed.

Further, the finishing step may be performed twice or more in one cutting step. After the finishing step is performed in the temperature maintaining step, the finishing step may be performed again if a measured shape accuracy does not satisfy a predetermined standard.

While representative embodiments of the present invention and several variations have been described, these are presented as examples and are not intended to limit the scope of the invention. These novel embodiments can be implemented in other various forms, and various omissions, replacements, and modifications can be made without departing from the technical concept of the present invention. These embodiments and modifications thereof are included in the scope and the gist of the invention and are included in the invention described in the claims and the equivalent scope thereof.

1. A method for producing a three-dimensional molded object, comprising:
a solidified layer forming step of performing, one or more times, a recoating step of forming a material layer on a predetermined molding region and a solidifying step of irradiating the material layer with a laser beam or an electron beam to form a solidified layer;
a temperature lowering step of cooling the solidified layer from a first temperature to a second temperature, the first temperature being equal to or higher than a martensitic transformation finish temperature of the solidified layer, and the second temperature being lower than the first temperature and equal to or lower than a martensitic transformation start temperature of the solidified layer;
a temperature maintaining step of maintaining a temperature of the solidified layer which is lowered to the second temperature in the temperature lowering step, at a predetermined cutting temperature;
a roughing step of cutting a surface of the solidified layer so as to leave a predetermined processing margin; and
a finishing step of cutting the surface of the solidified layer so as to leave a processing margin smaller than the predetermined processing margin left in the roughing step, wherein
the roughing step is started during the temperature lowering step; and
the finishing step is performed during the temperature maintaining step.

2. The method of claim 1, wherein the cutting temperature is equal to the second temperature.

3. The method of claim 1, wherein the cutting temperature is normal temperature.

4. The method of claim 1, wherein
a duration of the roughing step is shorter than a duration of the temperature lowering step, and
the roughing step is completed before completion of the temperature lowering step.

5. The method of claim 1, wherein the material layer and the solidified layer are maintained at the first temperature during the solidified layer forming step.
